(19) United States
(12) Patent Application Publication
(10) Pub. No.: US 2020/0212731 A1
(43) Pub. Date: Jul. 2, 2020

(54) STATOR AND MOTOR

(71) Applicant: Toyota Jidosha Kabushiki Kaisha, Toyota-shi (JP)

(72) Inventors: Masashi Matsumoto, Nagoya-shi (JP); Haruki Kusamaki, Okazaki-shi (JP); Hazuki Kawamura, Nisshin-shi (JP); Kohei Watanabe, Okazaki-shi (JP); Yuki Tanaka, Toyota-shi (JP)

(73) Assignee: TOYOTA JIDOSHA KABUSHIKI KAISHA, Toyota-shi (JP)

(21) Appl. No.: 16/711,558

(22) Filed: Dec. 12, 2019

(30) Foreign Application Priority Data
Dec. 26, 2018 (JP) 2018-242872

(51) Int. Cl. H02K 1/14; H02K 1/27; H02K 1/20; H02K 1/16; H02K 9/19; H02K 1/18

(52) U.S. Cl. CPC H02K 1/146; H02K 1/276; H02K 1/18; H02K 1/16; H02K 9/19; H02K 1/20

(57) ABSTRACT

A stator includes a stator core having an annular shape, the stator core being wound with a coil. The stator core includes a plurality of magnetic plates and a porous body intervening between the plurality of magnetic plates, the plurality of magnetic plates and the porous body being layered.

### CROSS REFERENCE TO RELATED APPLICATION

This application claims priority to Japanese Patent Application No. 2018-242872 filed on Dec. 26, 2018, which is incorporated herein by reference in its entirety including the specification, claims, drawings, and abstract.

### TECHNICAL FIELD

The present disclosure relates to a stator including a stator core wound with a coil, and to a motor including the stator.

### BACKGROUND

A high-output motor such as a motor for driving a vehicle generates a large amount of heat. Thus, a rotor and a stator are often cooled by a refrigerant such as oil (e.g., automatic transmission fluid: ATF). For effective cooling by such a refrigerant, various proposals have been made. JP 2009-50105 A discloses a proposal in which a porous body is disposed between a stator and a case, and a refrigerant is supplied to the porous body to promote cooling of the stator.

Here, according to JP 2009-50105 A, the outer circumferential side of the stator core is put into contact with the refrigerant to cool the stator. On the other hand, the temperature of the stator is increased due to heat generated by the coil. Thus, it is desirable to more effectively cool the coil located on the inner circumferential side of the stator core.

### SUMMARY

According to the present disclosure, a stator includes a stator core having an annular shape, the stator core being wound with a coil, the stator core including a plurality of magnetic plates and a porous body intervening between the plurality of magnetic plates, the plurality of magnetic plates and the porous body being layered.

The stator core may include: a yoke having an annular shape; and teeth extending radially inward from the yoke, the teeth being wound with the coil, in which both of the yoke and the teeth may include the plurality of magnetic plates and the porous body intervening between the plurality of magnetic plates, the plurality of magnetic plates and the porous body being layered.

The magnetic plates and the porous body may be identical in shape.

Furthermore, according to the present disclosure, a motor includes: a stator including: a stator core having an annular shape, the stator core being wound with a coil;

and a rotor including a plurality of permanent magnet units disposed inside the stator with a predetermined gap, the plurality of permanent magnet units being located near a circumferential edge of the rotor, in which the stator core includes a plurality of magnetic plates and a porous body intervening between the plurality of magnetic plates, the plurality of magnetic plates and the porous body being layered, and a refrigerant supplied inside the rotor passes through a porous portion, and the refrigerant having passed is discharged from an outer circumference of the rotor.

The permanent magnet units may each have a magnet main body and the porous portion provided in contact with the magnet main body, and the refrigerant supplied inside the rotor may pass through the porous portion, and the refrigerant having passed may be discharged from the outer circumference of the rotor.

According to the present disclosure, in the stator core, the porous body intervenes between the magnetic plates. Therefore, the refrigerant can be supplied to the coil via the porous body, and the refrigerant supplied can effectively cool the stator.

### BRIEF DESCRIPTION OF DRAWINGS

Embodiment(s) of the present disclosure will be described based on the following figures, wherein:

FIG. 1 is a view of a schematic configuration of a motor;

FIG. 2 is a perspective view of a stator core and the insertion direction of a segment coil;

FIG. 3 is a view of the stator core wound with a coil;

FIG. 4 is a cross-sectional view of the stator core in a plane passing through the central axis of the stator core;

FIG. 5 is a view of a schematic configuration (another embodiment) of a motor;

FIG. 6 is a view of a rotor viewed axially;

FIG. 7A is a front view of a permanent magnet unit in the longitudinal direction thereof; and

FIG. 7B is a cross-sectional view taken along line A-A of FIG. 7A.

### DESCRIPTION OF EMBODIMENTS

Hereinafter, embodiments of the present disclosure will be described by reference to the drawings. Note that the present disclosure is not limited to the embodiments described herein.

<Configuration of Motor>

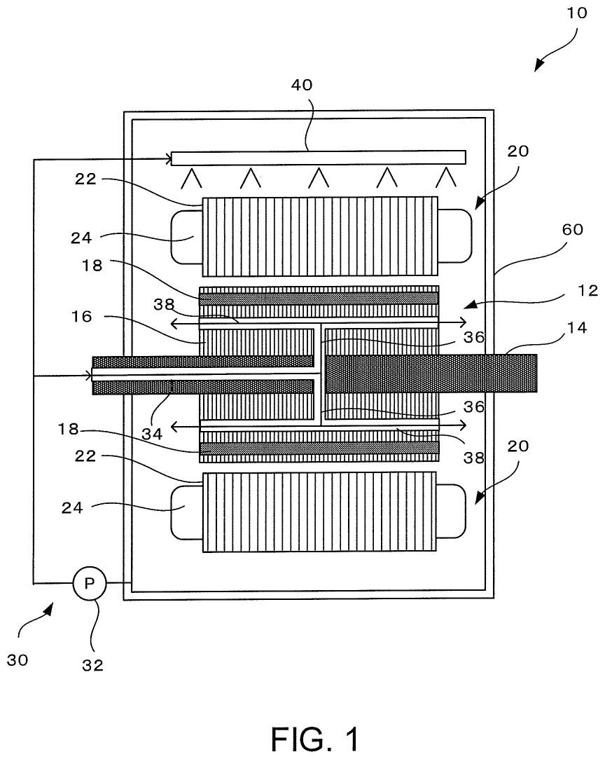

FIG. 1 is a view of a schematic configuration of a motor 10. As illustrated in FIG. 1, the motor 10 includes a rotor 12 and a stator 20 in a case 60.

The rotor 12 has a rotor core 16 secured to a rotor shaft 14 rotatably supported to the case 60 via a bearing (not illustrated). The rotor core 16 has a cylindrical shape, and a plurality of permanent magnet units 18 extending axially is provided at a location near the outer circumference of the rotor core 16.

The stator 20 has an annular shape, and is held in the case 60 such that the inner circumferential side of the stator 20 is opposed to the outer circumference of the rotor 12. In addition, the stator 20 has a stator core 22, and a coil 24 wound around teeth provided on the inner circumferential side of the stator core 22. FIG. 1 illustrates the coil ends of the coil 24 projecting axially from the stator core 22.

An alternating-current drive current is supplied to the coil 24 of the stator 20, and an electromagnetic force in the coil 24 generated by the supplied alternating-current drive supplied causes the rotor 12 to rotate in relation to the stator 20.

According to the present embodiment, the motor 10 is provided with a cooling apparatus 30 that circulates a refrigerant (oil) through the rotor 12 and the stator 20 to thereby cool the rotor 12 and the stator 20. That is, a refrigerant accumulated in the inner bottom of the case 60 is cooled as required, and then is supplied to the rotor 12 and the stator 20 through a pump 32. A flow passage 34 extending axially is provided inside the rotor shaft 14. A flow passage 38 is connected to the flow passage 34 via a flow passage 36 extending radially, the flow passage 38 extending axially in the rotor core 16 and having open ends. Thus, supplying the refrigerant to the flow passage 34 through the pump 32 causes flow of the refrigerant supplied through the rotor core 16, and then the refrigerant having flowed exits the rotor core 16 and returns to the inner bottom of the case 60.

In this example, the refrigerant is caused to flow out from the flow passage 38 in the axial direction of the rotor core 16. The present disclosure, however, is not limited to this example, and a flow passage in the radial direction leading to the circumferential face of the rotor core 16 may be provided to cause the the refrigerant to flow to the stator 20 from the flow passage. This arrangement enables supply of the refrigerant to the stator 20 from the inside of the stator 20, so that the refrigerant can also be supplied to the stator 20.

Furthermore, a cooling pipe 40 having a plurality of discharge ports on the lower side thereof is provided above the stator core 22. With this arrangement, supply of the refrigerant to the cooling pipe 40 through the pump 32 causes the refrigerant to fall to the stator core 22 and the coil 24, and then the refrigerant having fallen returns to the inner bottom of the case 60.

In such a manner, the cooling apparatus 30 cools the rotor 12 and the stator 20.

<Configuration of Stator Core>

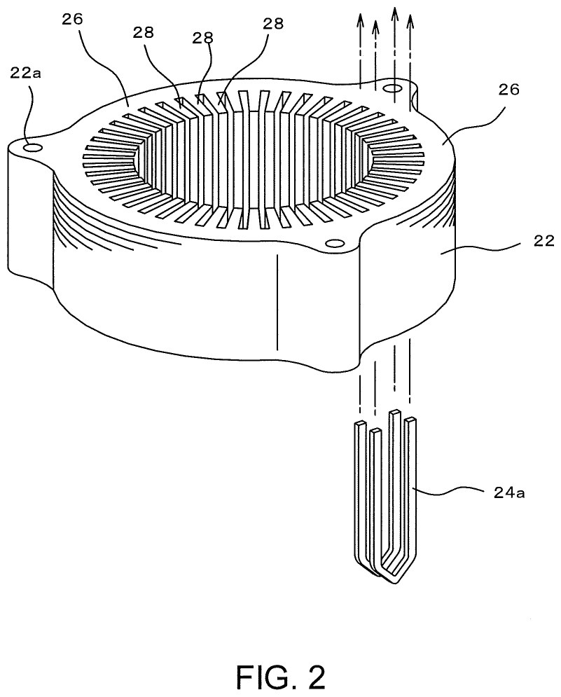

FIG. 2 is a perspective view of the stator core 22. The stator core 22 has a yoke 26 having an annular shape, and a plurality of teeth 28 projecting radially inward from the yoke 26. Paired legs of a segment coil 24a in a U shape are inserted into slots between the teeth 28. Then, a leading end of the segment coil 24a projecting from the stator core 22 is bent and connected to a different segment coil 24a for formation of the coil 24. The yoke 26 has three locations that bulge radially outward, and bolting holes 22a are formed at the three locations, respectively.

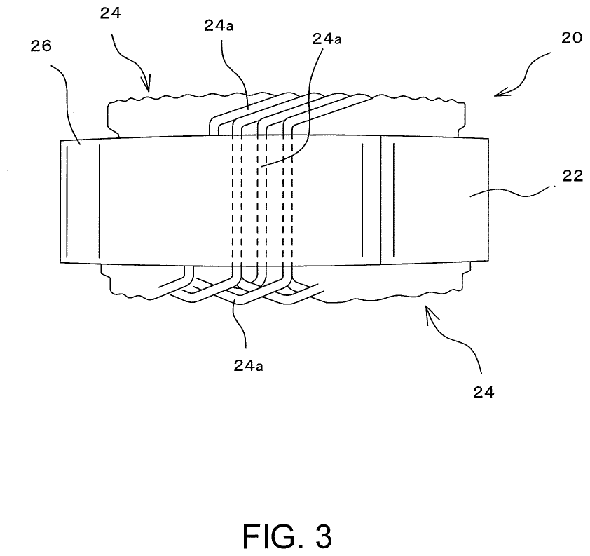

FIG. 3 is a view of the stator core 22 wound with the coil 24. Both legs of the segment coil 24a are inserted into two slots of the stator core 22. A leading end of the segment coil 24a is connected to a leading end of a different segment coil 24a for formation of the coil 24 having three phases.

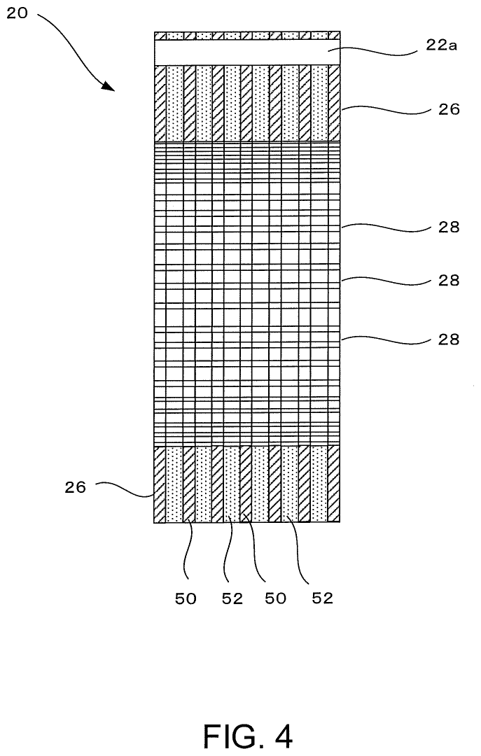

FIG. 4 is a cross-sectional view of the stator core 22 in a plane passing through the central axis of the stator core 22. As illustrated in FIG. 4, the stator core 22 includes magnetic plates 50 and porous bodies 52 each intervening between adjacent magnetic plates 50, the magnetic plates 50 and the porous bodies 52 being layered. That is, the magnetic plates 50 each having an annular shape and the porous bodies 52 each having an annular shape are layered alternately to form the stator core 22 having a hollow cylindrical shape. According to the embodiment, the magnetic plates 50 and the porous bodies 52 are identical in shape, and both of the yoke 26 and the teeth 28 include the magnetic plates 50 and the porous bodies 52 layered. FIG. 4 illustrates a cross section of the upper portion and the lower portion of the stator core 22, and the leading ends of the teeth 28 are seen inside the middle portion. In order to make the strength of the stator core 22 sufficient and not to narrow the slots, the porous bodies 52 can be identical in shape to the magnetic plates 50, and the porous bodies 52 may be provided with an optional number of holes to facilitate flow communication of the refrigerant.

Here, each of the magnetic plates 50 can include, for example, an electromagnetic steel plate having an insulating film formed on the surface thereof, such an electromagnetic steel plate included in a conventional stator core. As each of the porous bodies 52, a porous body having open-cell pores is adopted such that the refrigerant can flow inside the porous body. Examples of the porous body 52 that can be adopted include various materials: porous synthetic resin; porous ceramic; porous glass; and porous metal. Various porous metals are commercially available and can be appropriately selected and used. In particular, use of a sheet-like porous metal facilitates the process.

Use of an insulating material as the porous body 52 allows omission of the insulation coating of the magnetic plate 50. When a metal is used as the porous body 52, for example, aluminum can be adopted. An insulating film on the magnetic plate 50 may eliminate a requirement for forming an insulating film on the surface of the porous body 52 even as a conductive material. An insulating film, however, may be provided on the magnetic plate 50.

Furthermore, the porous body 52 can also serve as a magnetic body, with use of a metal such as iron or an iron alloy. In such a case, the porous body 52 can be used as part of a magnetic pole.

For the stator 20 including such a stator core 22, for example, when the refrigerant is injected from above, the refrigerant passes through the pores of the porous body 52 to reach inside the slots. Thus, the coil 24 serving as a heat generation source and the refrigerant come into direct contact with each other to exchange heat. As a result, the refrigerant can effectively cool the stator 20. In addition to the flow of the refrigerant inside the porous body 52, the refrigerant also comes in to contact with the respective surfaces of the magnetic plates 50 adjacent to respective sides of the porous body 52. Therefore, the entirety of the stator 20 can be cooled effectively. As described above, when the refrigerant is discharged from the outer circumferential face of the rotor 12, the discharged refrigerant is also supplied to the inner circumferential side of the porous body 52 of the stator 20. Thus, the refrigerant discharged from the rotor 12 enters the porous body 52 of the stator 20, and the stator 20 can be cooled effectively.

### Another Configuration Example

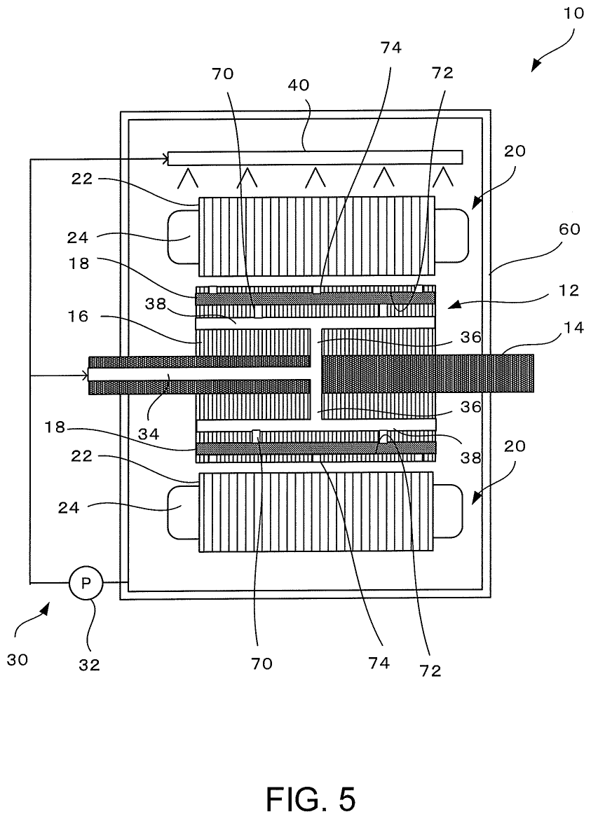

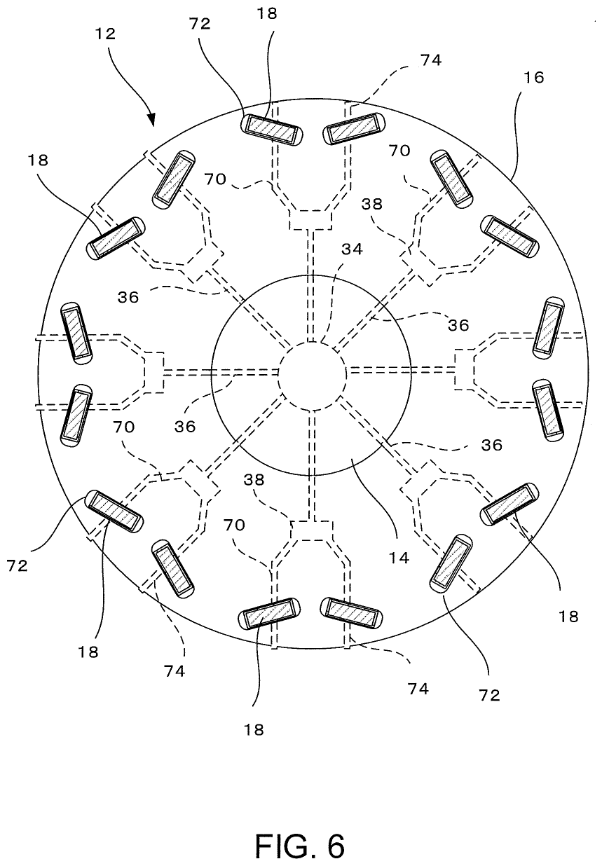

Another embodiment in which the flow passages for the refrigerant in the rotor 12 are modified will be described. FIG. 5 is a view of a schematic configuration of a motor, and FIG. 6 is a view of a rotor 12 viewed axially. As illustrated in FIGS. 5 and 6, a flow passage 34 extending axially is provided in a rotor shaft 14, and a plurality of flow passages 36 are provided radially outward from the flow passage 34. Each of the flow passages 36 extends from inside the rotor shaft 14 to inside a rotor core 16, and is connected to a flow passage 38 extending axially inside the rotor core 16.

A plurality of flow passages 70 are connected to the flow passage 38, the flow passages 70 extending radially further toward the outer circumferential side of the rotor core 16. The flow passages 70 put the flow passage 38 into connection with a plurality of magnet holes 72 extending axially. A plurality of flow passages 74 is connected to the magnet holes 72, respectively. The flow passages 74 extend radially to the outer circumferential end of the rotor core 16, the flow passages 74 being open to the outer circumference of the rotor core 16. With this arrangement, a refrigerant from the flow passage 38 is discharged radially from the rotor core 16 through the flow passages 70, the magnet holes 72, and the flow passages 74, and then sprayed to the inner circumferential side of the stator 20 opposed to the rotor core 16. Permanent magnet units 18 are inserted in the magnet holes 72, respectively. Each of the permanent magnet units 18, however, has a porous body that allows the refrigerant to pass therethrough. Here, in this example, both of the axial ends of the flow passage 38 are closed, and the refrigerant flows to the magnet holes 72. Both ends of the flow passage 38, however, may be open so as to appropriately maintain the flow rate of each flow passage.

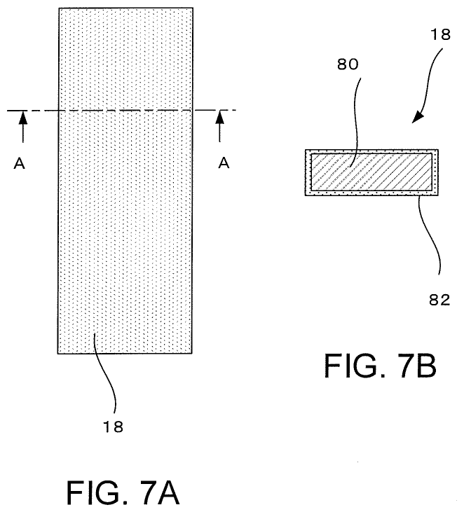

FIG. 7A is a front view of the permanent magnet unit 18 in the longitudinal direction thereof. FIG. 7B is a cross-sectional view taken along line A-A of FIG. 7A. According to this example, the permanent magnet unit 18 includes a magnet main body 80 and a porous portion 82. That is, the porous portion 82 is provided covering (surrounding) the four side faces of the permanent magnet unit 18 having a rectangular column shape. With this arrangement, the porous portion 82 is located between the inner face of the magnet hole 72 and the outer face of the permanent magnet unit 18. The porous portion 82 can include a material similar to the material of the porous body 52 described above.

Here, as illustrated in FIG. 6, each of the magnet holes 72 is formed slightly larger than the permanent magnet unit 18 inserted therein. In particular, the magnet hole 72 has a space extending axially, at each circumferential end of the magnet hole 72. An adhesive (e.g., high temperature resistant epoxy adhesive) or the like may be inserted into the space, or the space may remain intact. In a case where the spaces remain intact, stoppers may be provided at the axial ends, respectively, the stoppers being formed by caulking the plurality of magnetic plates (e.g., electromagnetic steel plates) included in the rotor core 16 so as to prevent coming off of the permanent magnet unit 18 from the magnet hole 72.

According to such a configuration, the porous portion 82 intervenes between the magnet main body 80 and the magnet hole 72. The refrigerant supplied from the flow passage 70 passes through the porous portion 82 and is discharged outward via the flow passage 74.

The permanent magnet units 18 generate a large amount of heat in the rotor 12. According to the present embodiment, the refrigerant comes into direct contact with the magnet main bodies 80 via the porous portions 82. Thus, the refrigerant can effectively cool the rotor 12.

In addition, according to the present embodiment, the refrigerant discharged from the flow passages 74 is sprayed to the inner circumferential side of the stator 20. Thus, the refrigerant is supplied directly to the inner circumferential side of the coil 24. Furthermore, as described above, the stator core 22 has the porous bodies 52. Thus, a portion of the refrigerant received on the respective inner circumferential sides of the teeth 28 can reach inside the porous bodies 52. As a result, the refrigerant discharged from the flow passages 74 of the rotor 12 can effectively cool the stator 20.

1. A stator comprising:
a stator core having an annular shape, the stator core being wound with a coil, the stator core including a plurality of magnetic plates and a porous body intervening between the plurality of magnetic plates, the plurality of magnetic plates and the porous body being layered.

2. The stator according to claim 1,
wherein the stator core includes:
a yoke having an annular shape; and
teeth extending radially inward from the yoke, the teeth being wound with the coil,
wherein both of the yoke and the teeth include the plurality of magnetic plates and the porous body intervening between the plurality of magnetic plates, the plurality of magnetic plates and the porous body being layered.

3. The stator according to claim 1,
wherein the plurality of magnetic plates and the porous body are identical in shape.

4. The stator according to claim 2,
wherein the plurality of magnetic plates and the porous body are identical in shape.

5. A motor comprising:
a stator including a stator core having an annular shape, the stator core being wound with a coil; and
a rotor including a plurality of permanent magnet units disposed inside the stator with a predetermined gap, the plurality of permanent magnet units being located near a circumferential edge of the rotor,
wherein the stator core includes a plurality of magnetic plates and a porous body intervening between the plurality of magnetic plates, the plurality of magnetic plates and the porous body being layered, and
a refrigerant supplied inside the rotor is discharged from an outer circumference of the rotor and the refrigerant discharged is supplied inside the porous body of the stator core.

6. The motor according to claim 5,
wherein the permanent magnet units each have a magnet main body and a porous portion provided in contact with the magnet main body, and the refrigerant supplied inside the rotor passes through the porous portion, and the refrigerant having passed is discharged from the outer circumference of the rotor.

7. The motor according to claim 5,
wherein the stator core includes:
a yoke having an annular shape; and
teeth extending radially inward from the yoke, the teeth being wound with the coil,
wherein both of the yoke and the teeth include the plurality of magnetic plates and the porous body intervening between the plurality of magnetic plates, the plurality of magnetic plates and the porous body being layered.

8. The motor according to claim 6,
wherein the stator core includes:
a yoke having an annular shape; and
teeth extending radially inward from the yoke, the teeth being wound with the coil,
wherein both of the yoke and the teeth include the plurality of magnetic plates and the porous body intervening between the plurality of magnetic plates, the plurality of magnetic plates and the porous body being layered.

9. The motor according to claim 5,
wherein the plurality of magnetic plates and the porous body are identical in shape.

10. The motor according to claim 6,
wherein the plurality of magnetic plates and the porous body are identical in shape.

11. The motor according to claim 7,
wherein the plurality of magnetic plates and the porous body are identical in shape.

12. The motor according to claim 8,
wherein the plurality of magnetic plates and the porous body are identical in shape.
